(19) United States
(12) Patent Application Publication
(10) Pub. No.: US 2006/0259655 A1
(43) Pub. Date: Nov. 16, 2006

(54) Test method, test circuit, test circuit building-in device, and computer program

(75) Inventors: Yasuhiro Nozaki, Tokyo (JP); Masanori Ushikubo, Yamahashi (JP)

Correspondence Address: NIXON PEABODY, LLP, 401 9TH STREET, NW, SUITE 900, WASHINGTON, DC, 20004-2128, US

(73) Assignee: Oki Electric Industry Co., Ltd., Tokyo (JP)

(21) Appl. No.: 11/359,364

(22) Filed: Feb. 23, 2006

(30) Foreign Application Priority Data
May 12, 2005 (JP) 2005-140121

(51) Int. Cl. G06F 3/00

(52) U.S. Cl. 710/14

(57) ABSTRACT

A test method includes starting a first phase test for a first block, starting a retention test for the first block shortly after the first phase test for the first block is over and starting a first phase test for a second block shortly after the first phase test for the first block is over.

### BACKGROUND OF THE INVENTION

1. Field of the Invention

The present invention relates to test methods, test circuits, test circuit building-in devices, and computer programs. Especially, the present invention relates to test methods, test circuits, test circuit devices, and computer programs for shortening a test time when a retention test is done during testing a user circuit including a plural of circuits (blocks). The above mentioned retention test is a test for ascertaining whether a value is retained, or not, after turning off the operation of the user circuit for a certain period. Generally, the period of turning off the operation of the user circuit during the retention test is longer than the period of tests except the retention test (phase tests).

2. Description of the Related Art

In tests procedures for LSI, an attempt is made to shorten the test time by simultaneous tests of every block, however, an voltage drop arises from an over peak-currency being caused by a simultaneous test of inner circuits of synchronization circuits. As the circuit does not work properly from the voltage drop thereof, the test might not be done accurately. Although there is a method for delaying the timing of the above peak currency by a delay device, the method cannot be applied to a test having shortened test period, for example, an at-speed test conducting a test at the maximum operating frequency of the circuit.

Three methods, (1) method for testing every block in serial, (2) method for testing every block simultaneously and delay the timing of the peak currency by a delay device, and (3) serial interleave method, will be explained as conventional test methods.

There is a simplified method for testing every block in serial order. This method has the longest test time. For example, the phases of every test are shown FIG. 5. The example in FIG. 5 shows the testing order from test of phase 1 (TP) to retention test 1 (TR) to test of phase 2 (TP) to retention test2 (TR) to test of phase 3.

The test time is n* (P*TP+(P−1)*TR), where TR is the retention test time, TP is the test time of every phase, n is the number of blocks, and P is the number of phases.

FIG. 6 shows an example of the case where the retention test time, TR, is 100 (ms), the test time of every phase, TP, is 1 (ms), the number of blocks, n, is 100, and the number of phases, P, is 3. The test time is 100*(3*1+(3−1)*100)=20300 (ms), as shown in FIG. 6.

There is a method for testing every block simultaneously and delay the timing of the peak currency by a delay device (refer to Patent Document 1). Although the test time is the shortest, the peak currency can not be delayed by a delay device, because the test period is short during the at-speed test.

The test time is P*TP+(P−1)*TR, where TR is the retention test time, TP is the test time of every phase, n is the number of blocks, P is the number of phases.

FIG. 7 shows an example of the case where the number of blocks is n, the retention test time, TR, is 100 (ms), the test time of every phase, TP, is 1 (ms), the number of phases, P, is 3. The test time is (3*1+(3−1)*100)=203 (ms), as shown in FIG. 7.

The serial interleave test method, one of the methods for testing every blocks, conducts test of every block by every phase. In the case of this method, the retention tests are done simultaneously, then two-time carrying-out of the retention test is enough. The reason why the retention tests are conducted simultaneously is that it can be done by an easy way, for example, halting clock inputs to the test circuits thereof.

The test time is n*P*TP+(P−1)*TR, where TR is the retention test time, TP is the test time of every phase, n is the number of blocks, P is the number of phases.

FIG. 8 shows an example of the case where the number of blocks is n, is 3, the retention test time, TR, is 100 (ms), the test time of every phase, TP, is 1 (ms), the number of phases, P, is 3. When the number of blocks ,n, is 100, the test time is 100*3*1+(3−1)*100)=500 (ms), as shown in FIG. 8.

Patent document No. 1: Japanese Patent Laid-Open No. 2740167.

### SUMMARY OF THE INVENTION

However, the above technology includes the following problems.

In the test according to the above article (1), there is no malfunction by the voltage drop thereof, the test period becomes longer, though. At the same time, in the test according to the above article (2), the test time is short, the peak current can not be reduced when the test period is short, however. Additionally, in the test according to the above article (3), there is no malfunction by the voltage drop thereof, because the test of every phase is done in serial. Moreover, the retention test is conducted only twice, and then the test time can be shortened. But, the effect of shortened test time becomes smaller as the number of blocks becomes larger.

The present invention is thought up from the above mentioned problems. Then the object of the invention is providing a new and revised test method, test circuit, test circuit building-in device, and computer program, being capable to shorten the test time and casing no problems of the voltage drop thereof at the same time.

To solve the before mentioned problems, from the first point of view of the present invention, the present invention provides the test method for testing a user circuits having a plural of blocks; the test method including the test of every block being done in serial and the retention test starting immediately after the phase test of every block is completed.

According to the above test, the waste of time for waiting till the test of other blocks are competed can be reduced, by carrying out the phase test of every block in serial and carrying out the retention test immediately after the phase test of every block is completed. And then the test period can be shortened. In other words, the status of waiting for completing of the test of other blocks, for example, the status of neglecting the output though the signal inputs into the circuit, or the status of no change of input signal like the retention test, can be eliminated. Subsequently, the test can be done for the test time as long as the parallel test, and the problem of the voltage drop never occurs, comparing with the conventional test methods.

To solve the above mentioned problems, a test circuit (150) being built in the user circuits including the plural of blocks is provided, according to the second point of view of the present invention. The test circuit according to the present invention includes a phase generation circuit (152), a retention counting circuit (154), and a comparing circuit (156). The phase generation circuit (152) generates the test pattern for the phase test of every block in the user circuit. The retention counting circuit (154) calculates the retention test time being considered when the phase generation circuit generates the test pattern. The comparing circuit (156) compares the expected value of the test pattern and the output from every block after the test pattern input into every block of the user circuit. And the feature of the test circuit is that the phase test of every block is done and the retention test is conducted immediately after the phase test of every block.

According to the above test, the waste of time for waiting till the test of other blocks are competed can be reduced, by carrying out the phase test of every block in serial and carrying out the retention test immediately after the phase test of every block is completed. And then the test period can be shortened. In other words, the status of waiting for completing of till the test of other blocks, for example, the status of neglecting the output though the signal inputs into the circuit, or the status of no change of input signal like the retention test, can be eliminated. Subsequently, the test can be done for the test period as long as the parallel test, and the problem of the voltage drop never occurs, comparing with the conventional test methods.

To solve the above mentioned problems, a test circuit building-in device (100) building test circuit in the user circuits having the plural of blocks is provided, according to the third point of view of the present invention. The test circuit (150) includes a phase generation circuit (152), a retention counting circuit (154), and a comparing circuit (156). The phase generation circuit (152) generates the test pattern for the phase test of every block of the user circuit. The retention counting circuit (154) calculates the retention test period being considered when the phase generation circuit generates the test pattem. The comparing circuit (156) compares the expected value of the test pattern and the output from every block after the test pattern input to every block of the user circuit. And the feature of the test circuit is that the phase test of every block is done and the retention test is conducted immediately after the phase test of every block.

According to the above building-in test circuit device, the waste of time for waiting till the test of other blocks are competed can be reduced, by carrying out the phase test of every block in serial and carrying out the retention test immediately after the phase test of every block is completed. And then the test period can be shortened. In other words, the status of waiting for completing of the test of other blocks, for example, the status of neglecting the output though the signal inputs into the circuit, or the status of no change of input signal like the retention test, can be eliminated. Subsequently, the test can be done for the test period as long as the parallel test, and the problem of the voltage drop never occurs, comparing with the conventional test methods.

Moreover, from another point of view of the present invention, a program making a computer have the function of the above mentioned building-in test circuit device according to the third point of view; and a recording media being able to read by the computer are provided. The program thereof can be written by any program language. At the same time, any recording media being used generally at the present for recording computer programs , for example, CD-ROM, DVD-ROM, or flexible disc, or any recording media being used in the future can be adopted as the recording media thereof.

Furthermore, in the above explanation, only for easy understanding, the reference numerals enclosed within parenthesis are written as examples of the corresponding elements in embodiments described as follows and in drawings shown as follows, and then the present invention does not limits to the above numerals.

As described before, according to the present invention, the waste of time for waiting till the test of other blocks are competed can be reduced, by carrying out the phase test of every block in serial and carrying out the retention test immediately after the phase test of every block is completed. And then the test period can be shortened. In other words, the status of waiting for completing of the test of other blocks, for example, the status of neglecting the output though the signal inputs into the circuit, or the status of no change of input signal like the retention test, can be eliminated. Subsequently, the test can be done for the test period as long as the parallel test, and the problem of the voltage drop never occurs, comparing with the conventional test methods.

### BRIEF DESCRIPTION OF THE DRAWINGS

FIG. 1 is a view of explanatory diagram showing a configuration of the test circuit building-in device.

FIG. 2 is a view of explanatory diagram showing a configuration of the retentiontest.

FIG. 3 is a view of flow chart showing an operation according to an embodiment of the present invention.

FIG. 4 is a view of timing chart showing a test timing according to an embodiment of the present invention.

FIG. 5 is a view of explanatory diagram showing the conventional test method (1).

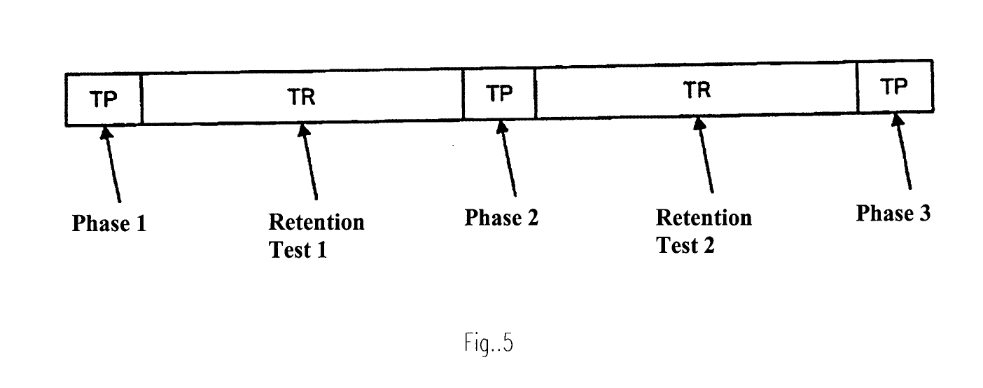

FIG. 6 is a view of explanatory diagram showing the conventional test method (1).

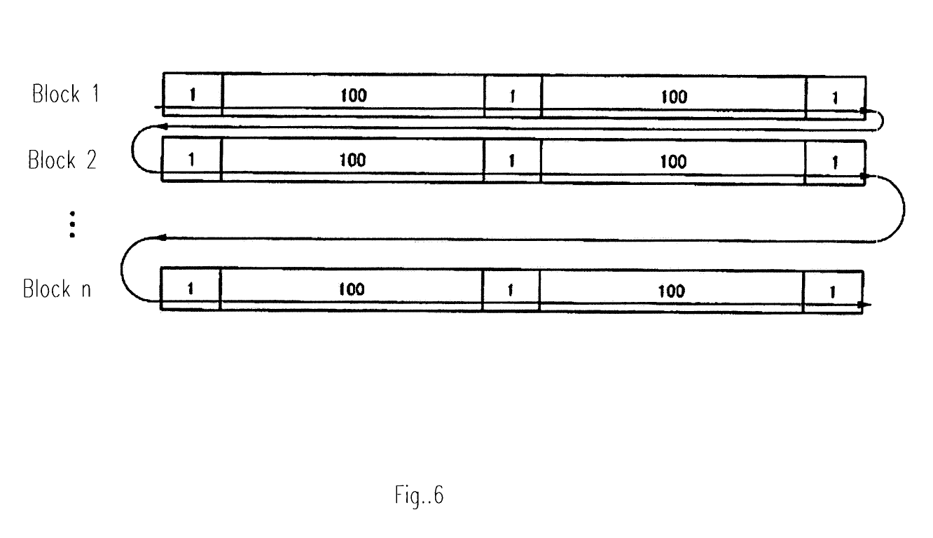

FIG. 7 is a view of explanatory diagram showing the conventional test method (2).

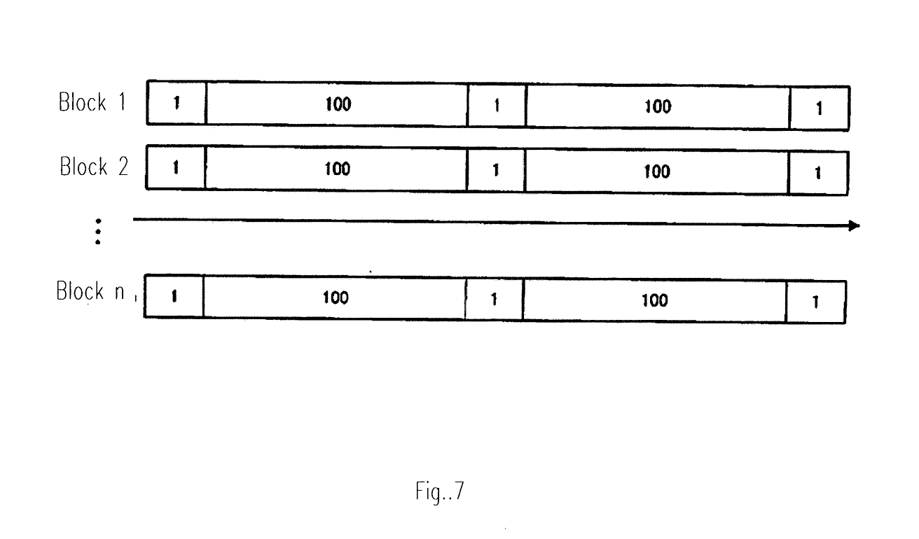

### DETAILED DESCRIPTION OF THE PREFERED EMBODIMENTS

The preferred embodiments of the test method, the test circuit, and the test circuit building-in device according to the present invention will be explained in details as below, referring to the attached drawings. In the descriptions and the drawings of the invention, duplicate explanations are omitted by providing the elements having the identical functions and configurations with the same numerals.

According to the embodiment of the invention, the phase test of every block is done in serial, while the retention test of every block is conducted immediately after the phase test is completed. In other words, the feature is that the retention tests are carried out at the same time, being delayed. As the operations are only halted during the retention, no influence arises even when the retention test of every block is done at the same time.

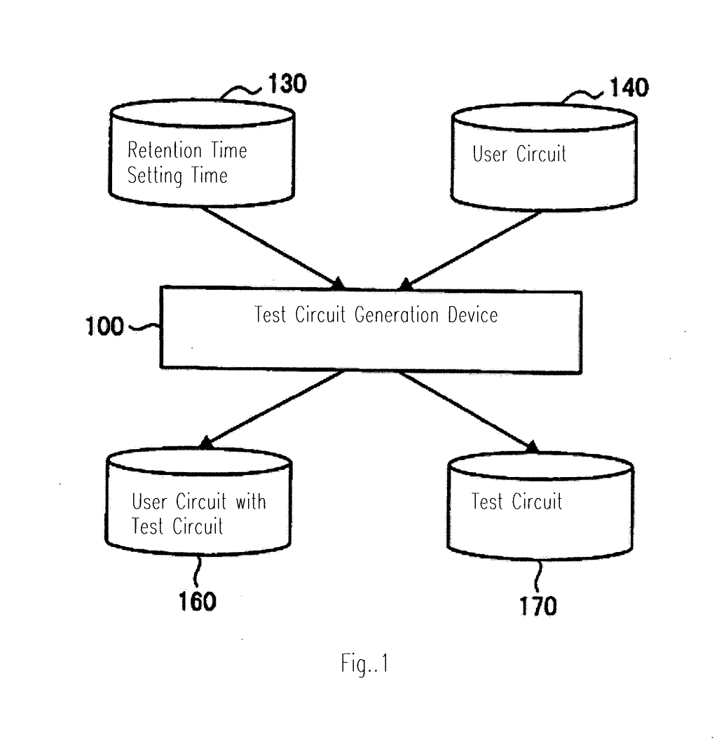

FIG. 1 shows the explanatory drawing of a test circuit building-in device according to the preferred embodiment of the invention. As shown in FIG. 1, a retention-time-setting data 130 setting the retention time thereof and an user circuit including blocks 140 input into a test circuit building-in device 100. Further, the test circuit building-in device 100 outputs an user circuit with test circuit 160 and a test pattern 170.

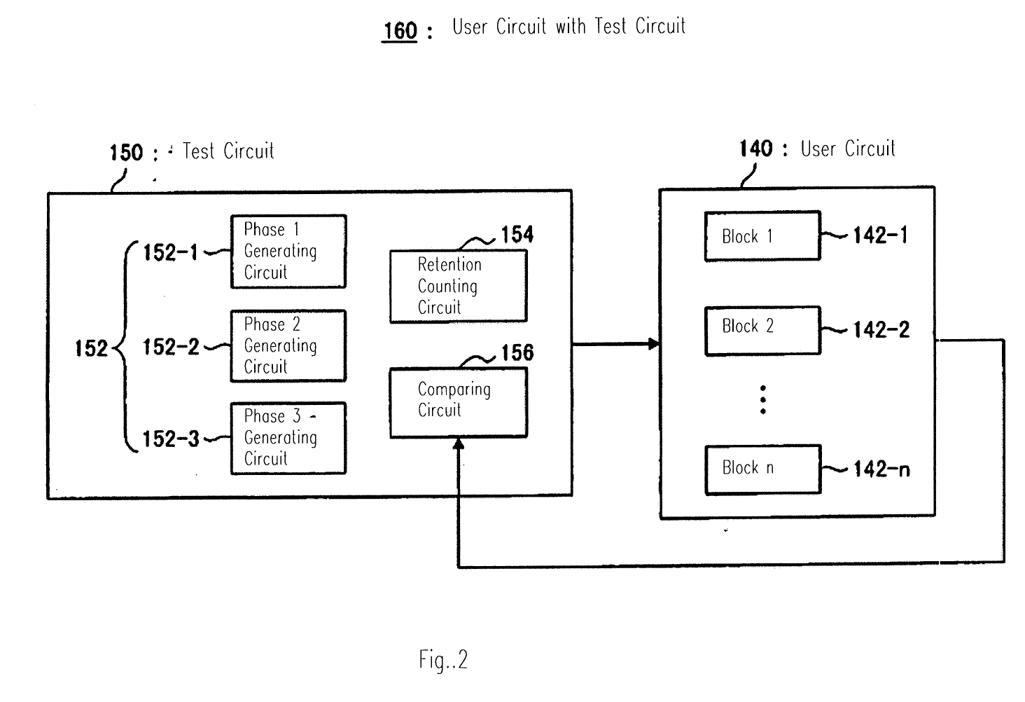

The test circuit building-in device 100 generates a test circuit 150 (FIG. 2) based on the retention setting data 130. And then, the user circuit with test circuit 160 is conformed by setting the test circuit 150 in the user circuit including blocks 140.

FIG. 2 is the explanatory diagram of the test circuit 150 generated by the test circuit building-in device 100. The test circuit 150 is configured to include a phase generation circuit 152, retention counting circuit 154, and a comparing circuit 156, as shown in FIG. 2.

The phase generation circuit 152 generates the test pattern (the line 170 of FIG. 1) considering the retention time when test pattern is provided every block. FIG. 2 illustrates the case where the number of phase is three. The phase generation circuit 152 thereof consists of phasel generation circuit 152-1, phase2 generation circuit 152-2, and the phase3 generation circuit 152-3. Any number can be set up as the number of phase generation circuit 152.

The retention counting circuit 154 calculates the retention time. The calculation thereby is needed when the phase generation circuit 152 generates patterns.

The comparing circuit 156 compares the expected value to the input pattern with the real output value and then outputs the comparing results when the pattern being generated by the test circuit inputs to every block.

The test circuit 150 being generated by the test circuit building-in device 100 is explained before. The test circuit building-in device 100 builds the test circuit 150 in the user circuit 140 and generates the test circuit with user circuit 160, as shown in FIG. 1 and FIG. 2.

At the same time, the test pattern 170 shown FIG. 1 generates the phase generating circuit 152 ( the phase 1 generating circuit 152-1, the phase 2 generating circuit 152-2, and the phase 3 generating circuit 152-3).

The test circuit building-in device 100 according to the present invention is explained before. The above test circuit building-in device 100 can make a computer have a function of the test circuit building-in device 100 by installing the computer program having the above mentioned function into the computer. The before mentioned computer program can be available in software markets by a specific recording media (for example, CD-ROM), or downloading through information networks.

According to the embodiment of the present invention, the phase of every bloc is conducted in serial, while the retention test of every block is done immediately after the phase test.

In other words, the feature is that the retention test is carried out, being delayed. As the operation is halted during the retention test, there is no consequence in the circuits thereof even when the retention test is done simultaneously.

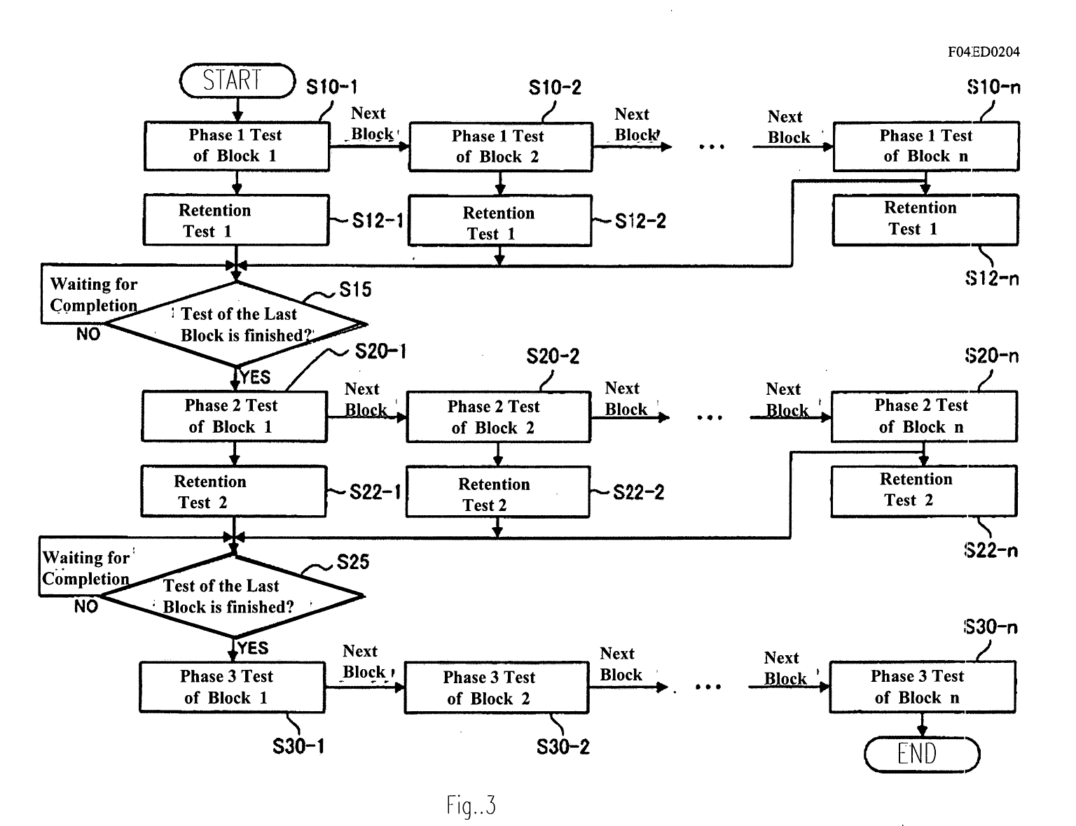

FIG. 3 is a view of a flow chart of operation according to the embodiment of the invention. First, the phase 1 test of block 1 is conducted (step S10-1). Immediately after the phase 1 test is completed, the retention test 1 (STEP S12-1) is done. In otherwords, The retention test 1 of block 1 (step S10-2) and the phase 1 test of block 2 (step S10-2) are carried out in parallel. Similarly, after the phase 1 test of block 2 is completed, the retention test 1 of block 2 (step S12-2) and the procedure of the next block are done in parallel.

When the phase 1 test of the last block n (step S10-n) is completed, the retention test 1 of block n (step S12-n) is started. At the same time, the completion of the phase 1 test of the last block n is acknowledged (step S15), and then the test procedure thereof moves to the phase 2.

The procedure of the phase 2 is the same as the before-mentioned procedure of the phasel. In other words, the procedure thereof is started with the phase 2 test of the block 1 (step S20-1). Immediately after the phase 2 test of block1, the retention test 2 (step S22-1) is done. More specifically, the retention test 2 of the block 2 (step S22-1) and the phase 2 test of block 2 (step S20-2) are carried out in parallel. Similarly, after the phase 2 test of block 2 is completed, the retention test 2 of block 2 (step S12-2) and the procedure of the next block are done in parallel.

When the phase 2 test of the last block n (step S20-n) is completed, the retention test 2 of block n (step S22-n) is started. At the same time, the completion of the phase 2 test of the last block n is acknowledged (step S15), and then the test procedure thereof moves to the phase 3.

In the phase 3, the test is conducted in order of from the phase 3 test of the block 1 (step S30-1), to the phase 3 test of the block 1 (step S30-2), - - - , to the phase 3 test of the block n (step S30-n).

The test time according to the embodiment of the invention is (P−1)*(TP+TR)+TP* n, where the retention time is TR, the test time of every phase is TP, the number of the block is n, and the number of the phase is P.

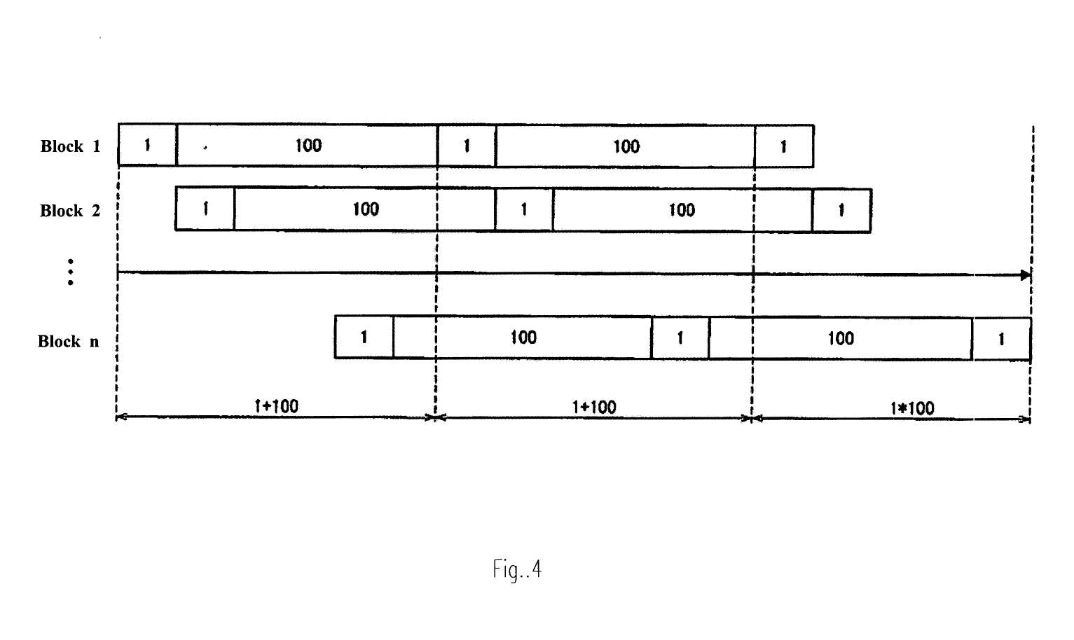

FIG. 4 is a view of the timing chart of the test timing explained before referring to FIG. 3. In FIG. 4, the timing of the case where the number of the block is n, the retention time is 100 (ms), the test time of every phase is 1 (ms), and the number of the phase is three is shown. The example of FIG. 4 is based on the condition that the result of multiplying the number of blocks by the phase test time is equal to or less than the retention time.

When the number of the block, n, is 100, the total test time according to the embodiment of the invention is (3−1)*(1+100)+1*100=302 (ms).

As explained before, according to the embodiment of the present invention, the phase of every bloc is conducted in serial, while the retention test of every block is done immediately after the phase test. In other words, the feature is that the retention test is carried out, being delayed. As the operation is halted during the retention test, there is no consequence in the circuits thereof even when the retention test is done simultaneously. In the above manner, the status of waiting for completing of the test of other blocks, for example, the status of neglecting the output though the signal inputs into the circuit, or the status of no change of input signal like the retention test, can be eliminated. Subsequently, the test can be done for the test time as long as the parallel test, and the problem of the voltage drop never occurs, comparing with the conventional test methods.

The explanation of the preferred embodiment of the test method, the test circuit, the test circuit building-in device, and the computer program according to the present invention is done before, referring to the attached drawings. The present invention does not limit to the embodiment thereof. It is obvious that the ordinary one in the art can conceive many kinds of changed or revised embodiment within the technical thought described in the scope of the invention, and then it is understandable that the changed or revised embodiment thereof should be within the scope of technology of the present invention.

The present invention is applicable to test methods, test circuits, test circuit building-in device, and computer programs, especially, for the case where a retention test is included in the test items of the user circuit having a plural of the circuits (blocks).

This is a counterpart of and claims priority to Japanese patent application Serial Number 140121/2005, filed on May 12, 2005, the subject matter of which is incorporated herein by reference.

What is claimed is:

1. A test method for testing an user circuit including a plural of blocks comprising: a step for conducting a phase test of said every block of plural of blocks in serial and conducting a retention test of said every block of plural of blocks immediately after said phase test.

2. A test circuit being built in an user circuit including a plural of blocks comprising: a phase generation circuit being configured to generate a test pattern for conducting said phase test of said every block of plural of blocks;
a retention counting circuit being configured to calculate a retention time being considered when said phase generation circuit generates said test pattern; and
a comparing circuit being configured to compare an expected output value for said test pattern being inputted to every block of said user circuit; with an output value from every block of said user circuit,
wherein said phase test of every block of said plural of blocks is conducted in serial and said retention test is conducted immediately after said phase test.

3. A test circuit building-in device for building a test circuit in an user circuit including a plural of blocks comprising, wherein said test circuit comprising:
a phase generation circuit being configured to generate a test pattern for conducting said phase test of every block of said plural of blocks;
a retention counting circuit being configured to calculate a retention time being considered when said phase generation circuit generates said test pattern; and
a comparing circuit being configured to compare an expected output value for said test pattern being inputted to every block of said user circuit; with an output value from every block of said user circuit,
wherein said phase test of said every block of plural of blocks is conducted in serial and said retention test is conducted immediately after said phase test.

4. A computer program being configured to provide a computer with a function of a test circuit building-in device according to claim 3.

5. A test method, comprising:
starting a first phase test for a first block;
starting a retention test for the first block shortly after the first phase test for the first block is over; and
starting first phase test for a second block shortly after the first phase test for the first block is over.

6. The test method according to claim 5, wherein the retention test for the first block is simultaneous with the first phase test for the second block.

7. The test method according to claim 6, further comprising starting a retention test for the second block shortly after the first phase test for the second block is over.

8. The test method according to claim 7, further comprising starting a second phase test for the first block shortly after the retention test for the first block is over.

9. The test method according to claim 8, wherein the second phase test for the first block is simultaneous with the retention test for the second block.

10. The test method according to claim 9, further comprising starting a second phase test for the second block shortly after the retention test for the second block is over.
